(19) United States
(12) Patent Application Publication
(10) Pub. No.: US 2025/0233797 A1
(43) Pub. Date: Jul. 17, 2025

(54) INVESTIGATION APPARATUS, COMMUNICATION SYSTEM, INVESTIGATION METHOD, AND PROGRAM

(71) Applicant: NEC Corporation, Tokyo (JP)

(72) Inventors: Yuki ASHINO, Tokyo (JP); Tatsuya Matsuura, Tokyo (JP)

(73) Assignee: NEC Corporation, Tokyo (JP)

(21) Appl. No.: 18/991,857

(22) Filed: Dec. 23, 2024

(30) Foreign Application Priority Data
Jan. 16, 2024 (JP) 2024-004581

(51) Int. Cl. H04L 41/12; H04L 41/22

(52) U.S. Cl. CPC H04L 41/12; H04L 41/22

(57) ABSTRACT

There is provided an investigation apparatus including: a location identification result acquisition part that acquires a location identification result of a target node to be investigated in a network; and a node visualization output part that visualizes and outputs the target node by disposing the target node on a map, on a basis of the location identification result, wherein the node visualization output part further outputs information on a region to which the target node belongs.

### FIELD

This application is based upon and claims the benefit of the priority of Japanese patent application No. 2024-004581, filed on Jan. 16, 2024, the disclosure of which is incorporated herein in its entirety by reference thereto.

The present disclosure relates to an investigation apparatus, a communication system, an investigation method, and a program that can determine a path(s) of communication on the Internet with high accuracy.

### BACKGROUND

IP (Internet Protocol) used for the Internet enables end-to-end two-way communications, regardless of the path. That is, IP realizes a mechanism in which a communication can be executed even if a communication path is changed, regardless of presence or absence of a malicious intent. Meanwhile, because the Internet has been created such that users can perform communications without being aware of the communication paths, they are rarely aware of the paths through which the communications are performed. Thus, for example, even when a communication is being performed through an area which has a high risk of a disaster or the like and in which the communication quality or reliability could consequently deteriorate, it is difficult to recognize the risk and to take measures such as disconnecting the communication.

Patent Literature (PTL) 1 discloses a technique of referring to a transit time zone in an e-mail header in order to detect a targeted attack e-mail. PTL 1 discloses “The transit time zone is acquired on a basis of time zone information included in Received information of one or more servers that are routed from the originating transmitting server to the receiving server.” and “Thus, on a basis of each received e-mail, each time zone information included in a transit server information (Receive information) is extracted as feature information. Targeted attack e-mails may be transmitted via foreign servers. Therefore, the detection accuracy of targeted attack e-mails is improved if the time zones of the servers through which the target e-mails are received are used as the feature information for comparison.”
PTL 1: Japanese Patent Kokai Publication No. 2013-236308 A

### SUMMARY

The disclosure of the above citation list is incorporated herein by reference thereto. The following analysis has been made by the present inventors.

As described above, the invention disclosed in PTL 1 aims to improve a detection accuracy of e-mails that are at risk of being targeted attack e-mails by comparing the time zone information of the transit server(s) included in a header of the received e-mail as a feature with a typical feature of the targeted attack e-mails.

However, because the time zone information of the transit server(s) can be arbitrarily changed by a server setting, the possibility of time zone information being forged cannot be denied according to the invention disclosed in PTL 1. Therefore, even if the e-mail passes through a server on a risky path, the disguise may cause an omission of detection of risky targeted-attack e-mails.

In one aspect of the present disclosure, it is an object to provide an investigation apparatus, a communication system, an investigation method, and a program that can investigate a path(s) of communication on the internet with high accurately and that can determine a high-risk path(s).

According to a first aspect of the present disclosure, there is provided an investigation apparatus, including: a location identification result acquisition part that acquires a location identification result of a target node to be investigated in a network; and a node visualization output part that visualizes and outputs the target node by disposing the target node on a map, on a basis of the location identification result; wherein the node visualization output part further outputs information on a region to which the target node belongs.

According to a second aspect of the present disclosure, there is provided a communication system, including: an investigation apparatus including a location identification result acquisition part that acquires a location identification result of a target node to be investigated in a network; a node visualization output part that visualizes and outputs the target node by disposing the target node on a map, on a basis of the location identification result, that outputs information on a region to which the target node belongs, and that calculates, visualizes and outputs a path to reach the target node; and a control signal transmission part that transmits a signal to a communication control apparatus that controls communication to execute control of predetermined communication according to the path calculated by the node visualization output part, and a communication control apparatus including a communication control part that receives a control signal transmitted from the control signal transmission part and executes control of a communication.

According to a third aspect of the present disclosure, there is provided an investigation method, causing a computer to execute steps of: acquiring a location identification result of a target node to be investigated in a network; and disposing the target node on a map on a basis of the location identification result and visualizing and outputting information on a region to which the target node belongs.

According to a fourth aspect of the present disclosure, there is provided a program, causing a computer to execute processing for: acquiring a location identification result of a target node to be investigated in a network; and disposing the target node on a map on a basis of the location identification result and visualizing and outputting information on a region to which the target node belongs.

The program can be recorded in a computer-readable storage medium. The storage medium may be a non-transitory storage medium such as a semiconductor memory, a hard disk, a magnetic recording medium, or an optical recording medium. The present disclosure can be embodied as a computer program product.

According to the individual aspects of the present disclosure, it is possible to provide an investigation apparatus, a communication system, an investigation method, and a program that can investigate a path(s) of communication on the internet with high accurately and that can determine a high-risk path(s).

### BRIEF DESCRIPTION OF DRAWINGS

FIG. 1 is a block diagram illustrating an example of a configuration of an investigation apparatus according to an example embodiment.

FIG. 2 is a block diagram illustrating an example of a configuration of an investigation apparatus according to the present disclosure.

FIG. 3 is a diagram schematically illustrating regional attribute values stored in a regional attribute value storage part in the investigation apparatus according to the present disclosure.

FIG. 4 is a diagram schematically illustrating regional information stored in a regional information storage part in the investigation apparatus according to the present disclosure.

FIG. 5 is a diagram illustrating an overview of an output result of a node visualization output part according to the present disclosure.

FIG. 6 is a flowchart illustrating an operation of the investigation apparatus according to the present disclosure.

FIG. 7 is a block diagram illustrating an example of a hardware configuration of the investigation apparatus according to the example embodiment of the present disclosure.

FIG. 8 is a block diagram illustrating an example of a configuration of an investigation apparatus according to the present disclosure.

FIG. 9 is a diagram illustrating a path calculation process of a node visualization output part in the investigation apparatus according to the present disclosure.

FIG. 10 is a diagram illustrating paths calculated by the node visualization output part in the investigation apparatus according to the present disclosure.

FIG. 11 is a flowchart illustrating an example of an operation of the investigation apparatus according to the example embodiment of the present disclosure.

FIG. 12 is a diagram illustrating an example of a configuration of a communication system according to an example embodiment of the present disclosure.

### EXAMPLE EMBODIMENTS

First, an overview of an example embodiment will be described. Note that reference signs in the drawings provided in this overview are for the sake of convenience for each element as an example to promote better understanding, and the description of this overview is not intended to impose any limitations.

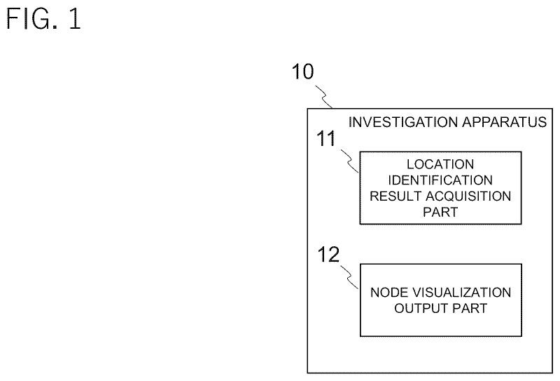

FIG. 1 is a block diagram illustrating an example of a configuration of an investigation apparatus according to an example embodiment. An investigation apparatus 10 according to an example embodiment is provided with a location identification result acquisition part 11 and a node visualization output part 12.

The location identification result acquisition part 11 acquires a location identification result(s) of one or more target node(s), which is a target(s) to be investigated in a network. The node visualization output part 12 visualizes and outputs the target node(s) by disposing thereof on a map, on a basis of the location identification result(s). In addition, the node visualization output part also outputs information about a region(s) to which the target node(s) belongs.

As described above, the investigation apparatus according to an example embodiment can locate a target node(s) on the Internet and can visualize and output the target node(s) by disposing the target node(s) on a map. In addition, the investigation apparatus can output information about a region(s) to which the target node(s) belongs. In this way, the investigation apparatus can evaluate and output, for example, a regional risk(s) or the like that exist on a path(s) that the target node(s) has.

### First Example Embodiment

### [Apparatus Configuration]

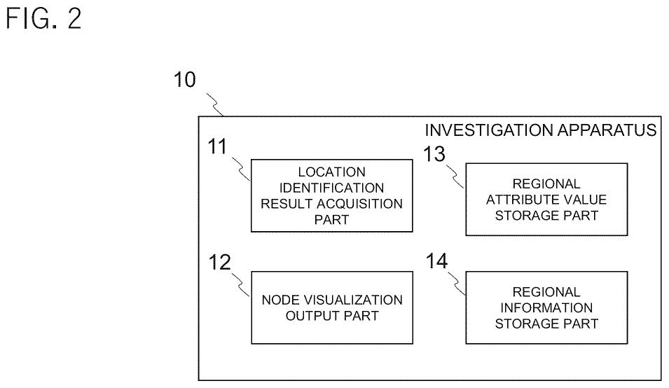

FIG. 2 illustrates an example of a configuration of an investigation apparatus according to a first example embodiment. An investigation apparatus 10 according to the first example embodiment is provided with a location identification result acquisition part 11, a node visualization output part 12, a regional attribute value storage part 13, and a regional information storage part 14. A feature of the present example embodiment is that the node visualization output part 12 also outputs information about a region(s) to which a target node(s) belongs, on a basis of a location identification result(s), a regional attribute value(s), and regional information.

The location identification result acquisition part 11 acquires a location identification result(s) of one or more target node(s), which is a target(s) to be investigated in a network. The “network” may include a closed network such as a LAN (Local Area Network) with restricted access and an open network such as the Internet, which anyone can access. The “target node” is a node to be investigated, and the “node” refers to a network device having a network interface on a network. The “node” may include a terminal, a server, a router, and a switch.

The “acquisition” here refers to temporary or permanent storage of calculated or generated data in a storage area of a computer. The “location identification” refers to identifying information about the physical location of a target node, the physical location being expressed on a certain scale. The physical location information may include absolute location information, such as indication by latitude and longitude, or location information identified from the direction and distance with respect to a particular location.

The location identification result may be acquired by directly visiting a target node and by acquiring the latitude and longitude of this location by a GPS (Global Positioning System) or the like to be uploaded to the investigation apparatus.

However, on the Internet, the location(s) of a target node(s) is not apparent, and the target nodes are installed not only domestically but also abroad. Thus, it is necessary to proceed with the location identification using, for example, an existing technique as described below.

The location identification result acquisition part 11 in the investigation apparatus 10 transmits an investigation packet P to another target node and receives a response packet R as a transmission result. Next, the location identification result acquisition part 11 acquires a transmission time Tp at which the investigation packet P was transmitted and a reception time Tr at which the response packet R was received. Next, the location identification result acquisition part 11 calculates a round-trip time RTT using the transmission time Tp, the reception time Tr, and equation (1).

$$Round - trip time RTT = Reception time Tr - Transmission time Tp \qquad ( 1 )$$

The location identification result acquisition part 11 acquires a propagation velocity Vm of the transmission medium between the another target node and the investigation apparatus 10 as a medium velocity. The distance to the another target node can be calculated using equation (2).

$$Distance r 1 = ( Medium velocity Vm \times Round - trip time RTT ) \div 2 \qquad ( 2 )$$

In addition to r1, the location identification result acquisition part 11 also calculates a distance (r2) between the another target node and another point and a distance (r3) between the another target node and still another point (these points may be nodes that have been newly acquired by investigation packets). Consequently, the location identification result acquisition part 11 can calculate the position coordinates (x, y) of the location of the another target node by so-called three-point positioning. That is, the location identification result acquisition part 11 calculates the coordinates (x, y) of the intersection of the circles of radii r1, r2, and r3 centered at the coordinates (x1, y1), (x2, y2), and (x3, y3) of three points, respectively.

$$( x - x 1 ) \hat{} 2 + ( y - y 1 ) \hat{} 2 = r 1 \hat{} 2 \\ ( x - x 2 ) \hat{} 2 + ( y - y 2 ) \hat{} 2 = r 2 \hat{} 2 \\ ( x - x 3 ) \hat{} 2 + ( y - y 3 ) \hat{} 2 = r 3 \hat{} 2$$

By solving the above x and y, the position coordinates (x, y) of the location of the target node can be calculated. The location identification result acquisition part 11 can further process the conversion of position coordinates to latitude and longitude to obtain latitude and longitude (φ, λ).

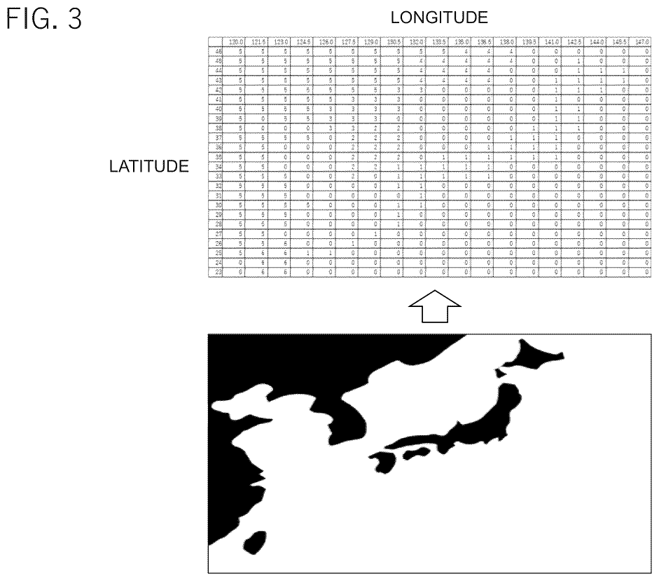

The regional attribute value storage part 13 stores regional attribute values, each of which is a value that is associated with a latitude and a longitude and each of which indicates an attribute of a region at the corresponding latitude and longitude. The regional attribute value storage part 13 stores a regional attribute value that corresponds to the latitude and longitude values, which are the result acquired by the location identification result acquisition part 11. FIG. 3 is a diagram schematically illustrating the regional attribute values stored in the regional attribute value storage part 13 in the investigation apparatus 10 according to the present disclosure. As illustrated in FIG. 3, a corresponding regional attribute value is assigned in a cell at the corresponding latitude and longitude on a map. The regional attribute value, which is a numerical value assigned, is a category indicating an attribute of the area at the corresponding latitude and longitude.

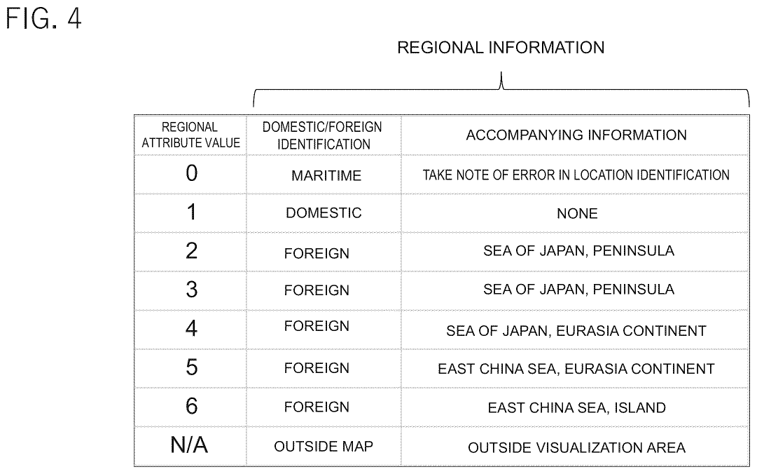

The regional information storage part 14 stores regional information, which is information associated with the regional attribute values and about the region. FIG. 4 is a diagram schematically illustrating the regional information stored in the regional information storage part 14 in the investigation apparatus 10 according to the present disclosure. As illustrated in FIG. 4, the regional information storage part 14 stores the regional attribute values and the regional information associated with the regional attribute values. The regional information may be configured with information on whether the region with the regional attribute value is domestic or foreign (domestic/foreign identification) and accompanying information that supplements the domestic/foreign identification information. As illustrated in FIG. 4, the accompanying information may provide at least the following information as regional information: whether their region is domestic or foreign, maritime or land, island or continental and so on.

If location identification result indicates that the region is outside of the map, the regional information is not possible to visualize as described below, and there may be regional information with an associated regional attribute value of “N/A (Not Applicable)”.

If the coverage region includes a high-risk area, such as a region where quality and reliability of communication may be degraded due to a high risk of disaster, etc., as described above, the regional information storage part 14 may store information indicating that the region having the regional attribute value as the regional information associated with the regional attribute value is at least a high-risk region.

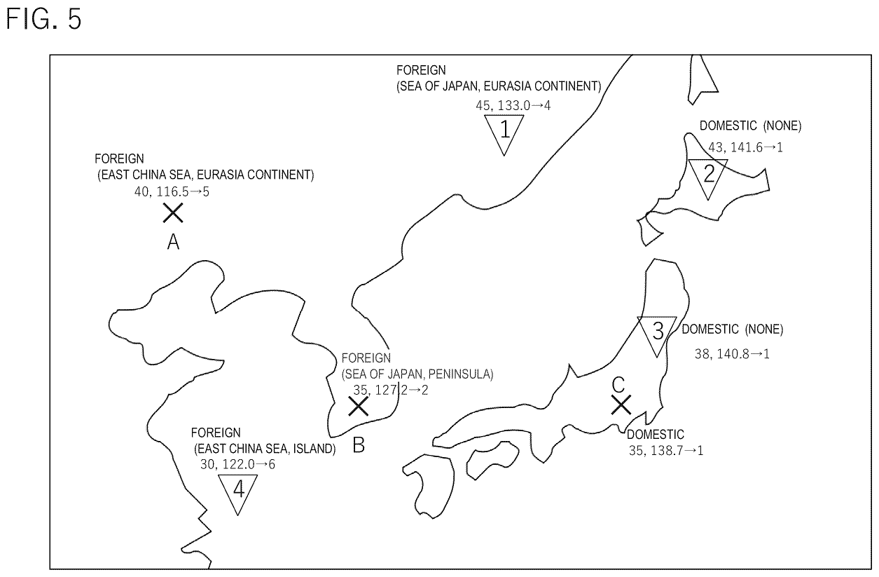

The above regional attribute value storage part 13 and the above regional information storage part 14 visualize only a part of Asia in the example illustrated in FIGS. 4 and 5, but naturally, they can be expanded to nodes in regions all over the world, and maps that span the entire world can also be used.

The node visualization output part 12 visualizes and outputs a target node(s) by disposing the target node(s) on a map, on a basis of a location identification result(s). Once the position information by latitude and longitude is acquired, the location on the map is identified and it can be placed.

FIG. 5 is a diagram illustrating an overview of an output result of the node visualization output part 12 according to the present disclosure. As illustrated in FIG. 5, target nodes 1 to 4 are output to a display device. These target nodes 1 to 4 are those that can be identified by calculating the position coordinates of the target node as described above from points A, B, and C (indicated by “x” in FIG. 5), whose latitude and longitude are known.

For example, target node 1 obtains RTT values by transmitting investigation packets from the nodes A, B, and C, respectively, to the target note 1. As described above, distances rA, rB, and rC from nodes A, B, and C to the target node 1, respectively, can be obtained from half the product of a medium velocity and the respective RTTs. The coordinates of the target node 1 are the intersection of circles of radii rA, rB, and rC with nodes A, B, and C as centers. Therefore, its coordinates can be obtained by solving the following simultaneous equations (3) using the known coordinates (xA, yA), (xB, yB) and (xC, yC) of nodes A, B and C.

$$( x - xA ) \hat{} 2 + ( y - yA ) \hat{} 2 = rA \hat{} 2 \\ ( x - xB ) \hat{} 2 + ( y - yB ) \hat{} 2 = rB \hat{} 2 \\ ( x - xC ) \hat{} 2 + ( y - yC ) \hat{} 2 = rC \hat{} 2 \qquad ( 3 )$$

The obtained coordinates (x, y) of the target node 1 are expressed on a plane rectangular coordinate system, so the coordinates are converted into an expression using a latitude and a longitude. As a result, 45 degrees north latitude and 133.0 degrees east longitude are obtained as the location identification result.

If the location identification result is an unstable value, extrapolation could be needed. Thus, the investigation apparatus 10 may be further provided with a location identification result edit part (not illustrated) that edits the location identification result.

The node visualization output part 12 also outputs information about the region(s) to which the target node(s) belongs, on a basis of the location identification result(s), the regional attribute value(s), and the regional information. Referring to the regional attribute value storage part 13, the value of the cell in the table corresponding to 45 degrees north latitude and 133.0 degrees east longitude, “4” is obtained as the regional attribute value (see FIG. 3). Next, referring to the regional information storage part 14 (see FIG. 4), the regional information pertaining to the regional attribute value “4” among the regional information is “Foreign” and “Sea of Japan and Eurasia” is obtained as the accompanying information. The regional information thus obtained is displayed together with the target node disposed on a map as illustrated in FIG. 5.

The node visualization output part 12 may output a predetermined warning if a path to reach a predetermined target node includes a maritime node. In addition, the node visualization output part 12 may output a predetermined warning if a path to reach a predetermined target node includes a node outside a visualization area. For example, as the predetermined warning, in FIG. 5, the maritime node could be warned by changing the display color or other display style, while a node outside the visualization area could be warned by outputting a warning sound from a speaker or other means.

### [Description of Operation]

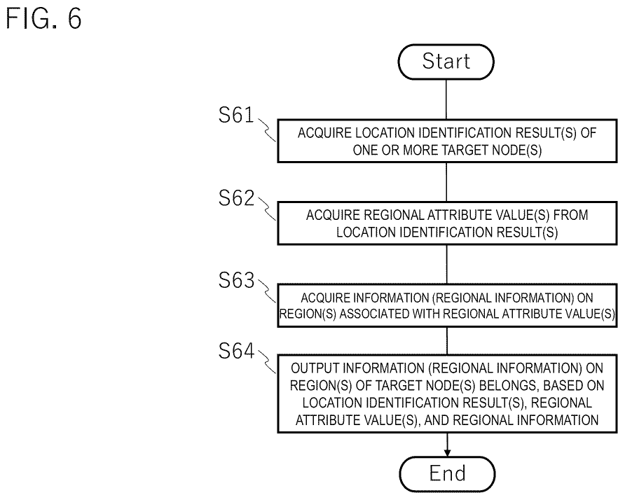

FIG. 6 is a flowchart illustrating an operation of the investigation apparatus according to the present disclosure. As illustrated in FIG. 6, first, the investigation apparatus acquires a location identification result(s) of one or more target node(s) (step S61). Next, the investigation apparatus acquires a regional attribute value(s) from the acquired location identification result(s) (step S62). Next, the investigation apparatus acquires information about a region(s) associated with the acquired regional attribute value(s) (step S63). Finally, the investigation apparatus outputs information (regional information) about the region(s) to which the target node(s) belongs, on a basis of the location identification result(s), the regional attribute value(s), and the regional information (step S64).

### [Hardware Configuration]

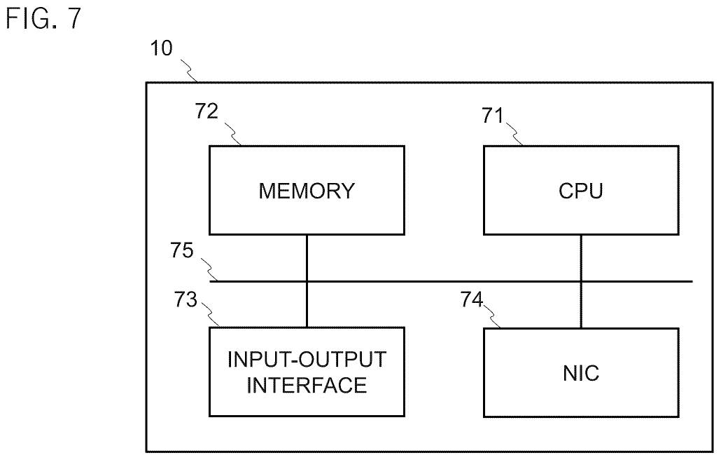

Next, a hardware configuration of the investigation apparatus according to the example embodiment of the present disclosure will be described. FIG. 7 is a block diagram illustrating an example of a hardware configuration of the investigation apparatus 10 according to the example embodiment of the present disclosure.

The investigation apparatus 10 can be configured by an information processing apparatus (a computer), and has a configuration illustrated as an example in FIG. 7. For example, the investigation apparatus 10 is provided with a CPU (Central Processing Unit) 71, a memory 72, an input-output interface 73, and a NIC (Network Interface Card) 74, which is communication means. These components are interconnected to each other via an internal bus 75.

However, the configuration illustrated in FIG. 7 is not intended to limit the hardware configuration of the individual device configured with the investigation apparatus 10. The investigation apparatus 10 may include hardware not illustrated, respectively, and may not have an input-output interface 73, if necessary. For example, the number of CPUs included in the investigation apparatus 10 is not limited to the example illustrated in FIG. 7. For example, a plurality of CPUs may be included in the individual device.

For example, the memory 72 is a RAM (Random Access Memory), a ROM (Read-Only Memory), or an auxiliary storage device (a hard disk or the like).

The input-output interface 73 is a means serving as an interface for a display device or an input device not illustrated. The display device is, for example, a liquid crystal display, and the input device is, for example, a device that receives user operations, such as a keyboard or a mouse.

The functions of the investigation apparatus 10 are realized by processing modules, which are a location identification result acquisition program and a node visualization output program, the table storing the regional attribute values, the table storing the regional information, and the media velocity (Vm), for example.

The above processing modules are realized, for example, by the CPU 71 executing programs stored in the memory 72, respectively. The program can be updated by downloading thereof over a network or by using a storage medium storing the program. In addition, the above-described processing modules may be realized by semiconductor chips. That is, there is means that executes the functions of the above-described processing modules by using some hardware and/or software.

### [Hardware Operation]

If the hardware of the investigation apparatus 10 starts the process, the location identification result acquisition program is invoked from the memory 72 and becomes executable by the CPU 71. This program causes investigation nodes S1 to S3, located at three locations (at least three locations, one of which may be the investigation apparatus 10) in a network, to transmit an investigation packet to a single target node and causes the single target node to receive a response packet, thereby obtaining round-trip time (RTT) values to store thereof in the memory 72. This program causes the CPU 71 to execute arithmetic processing for calculating a value of (each RTT value×Vm)/2 for these three RTT values, so as to obtain distances r1 to r3. Next, r1 to r3 and the known coordinate values (x1, y1), (x2, y2), and (x2, y2) of the investigation nodes S1 to S3 are assigned to the above-described equations (3), and the CPU 71 executes arithmetic processing in which equations (3) are calculated as simultaneous equations to acquire a solution (x,y). This series of processes is performed for N target nodes to obtain the coordinate values (x1, y1) to (xN, yN) of the target nodes 1 to N. These coordinates are temporarily stored in the memory 72.

The CPU 71 converts the coordinates (x1, y1) to (xN, yN) into latitudes and longitudes (φ1, λ1) to (φN, λN) using a known technique. Next, the node visualization output program is invoked from the memory 72 by the CPU 71 and becomes executable. This program reads out the table (illustrated in FIG. 3) that stores the regional attribute values from the memory 72. Next, the program reads out the coordinates values (φ1, λ1) to (φN, λN), which are the location identification results, and acquires regional attribute values a1 to aN in the cells corresponding to the above coordinates.

Next, the program reads out the table (illustrated in FIG. 4) that stores the regional information from the memory 72. The program reads out the stored regional information from the acquired regional attribute values a1 to aN corresponding to the individual target nodes.

The read out regional attribute values and regional information are visualized by the program and output to the input-output interface 73 such as a display (see FIG. 5). These may be output by being disposed on the screen corresponding to the corresponding latitude and longitude on the map read out in advance, along with icons, etc.

As described above, the investigation apparatus according to the present example embodiment can identify the locations of the individual target nodes and can visualize information about the regions to which the individual target nodes belong on a map, on a basis of their respective latitudes and longitudes. This makes it possible to easily visualize what path or environment under which the communication is taking place.

### Second Example Embodiment

### [Apparatus Configuration]

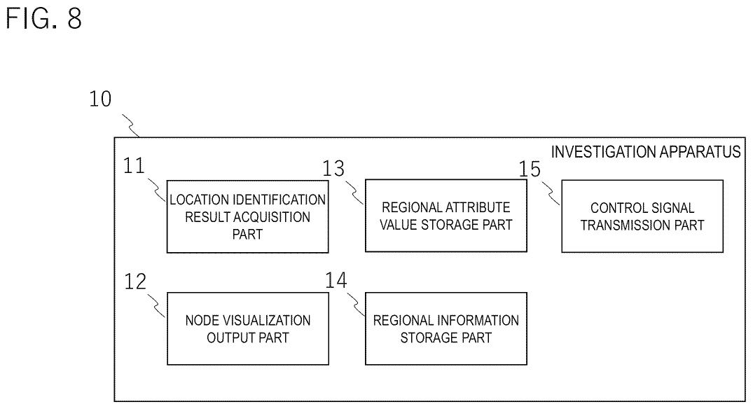

FIG. 8 illustrates an example of a configuration of an investigation apparatus according to a second example embodiment. An investigation apparatus 10 according to a second example embodiment is provided with a location identification result acquisition part 11, a node visualization output part 12, a regional attribute value storage part 13, and a regional information storage part 14. Since these components have already been described in the above example embodiment, description thereof will be omitted. Features of the present example embodiment are, for example, that the investigation apparatus 10 is additionally provided with a control signal transmission part 15 and that the node visualization output part 12 can also calculate, visualize, and output a path(s) to reach a target node(s).

The node visualization output part 12 according to the present example embodiment can calculate, visualize, and output a path(s) to reach a target node(s). For example, the node visualization output part 12 can acquire addresses of target nodes, routers, and other nodes on the path by transmitting a traceroute command, etc. to a target node.

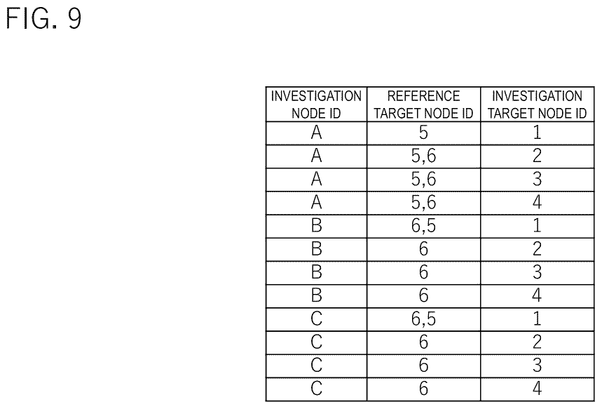

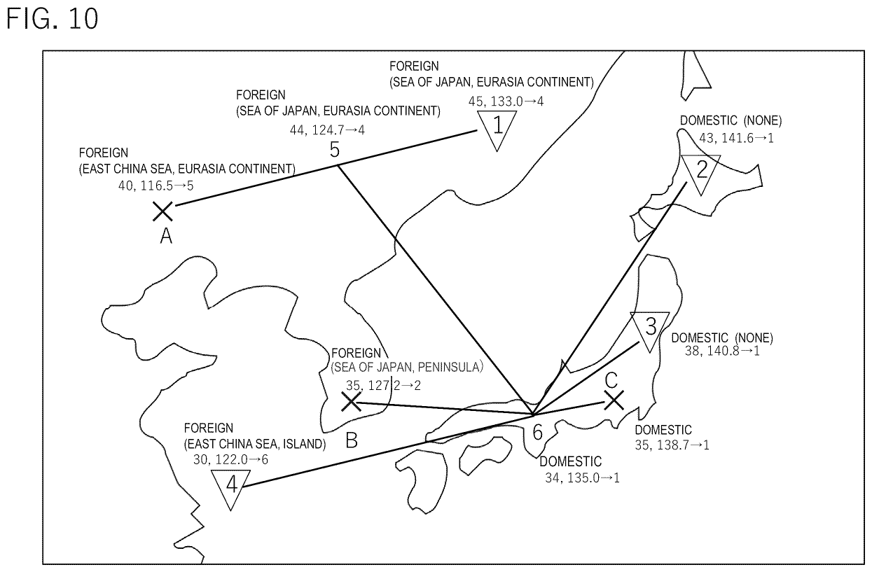

FIG. 9 is a diagram illustrating a path calculation process of the node visualization output part 12 in the investigation apparatus according to the present disclosure. As illustrated in FIG. 9, there are an investigation node ID that is an ID of the investigation node that transmits investigation packets, an investigation target node ID that is an ID of an investigation target node to which the investigation packets are transmitted, and a reference target node ID that is an ID of a reference node at a transit location that intervenes between the investigation node and the investigation target node. FIG. 9 illustrates a mode in which reference nodes, which are nodes 5 and 6, have been found and recognized as those on paths, as a result of the transmission of investigation packets from investigation nodes A, B, and C to the investigation target nodes in FIG. 9. FIG. 10 illustrates an output of a graphical representation of the path on a basis of the information in FIG. 9 by line segments on a map.

The control signal transmission part 15 transmits a signal for causing a communication control apparatus that controls communication to execute predetermined communication control according to the path calculated by the node visualization output part 12. The “according to the path calculated” includes, for example, a case in which a node outside the visualization area is included in a path to reach a predetermined target node. The “communication control apparatus” refers to a network device such as a router. The “predetermined communication control” could be disconnection of a communication, detour to another route, etc.

For example, if a predetermined change is made within a predetermined time period on the path to reach a predetermined target node in the node visualization output part 12, the control signal transmission part 15 may execute a process to transmit a control signal to cause control of the predetermined communication to be executed.

Concretely, if a path length to reach a predetermined target node is changed by a predetermined amount or more within a predetermined time period in the node visualization output part 12, the control signal transmission part 15 may execute a process such as transmitting a control signal to cause control to close the path leading to the target node. The “path length” of an individual path can be calculated on a basis of a corresponding path traveling time that can be investigated with an investigation packet (using, for example, a ping or traceroute command) and the media velocity (Vm) of the individual path. This is because if the path length suddenly becomes longer than the path length at the timing of the previous node visualization output, there is a high possibility that some abnormality has occurred on the network and that the path has become a detour route, and even if there is a prospect of recovery, it is likely to remain a high-risk route. If there is a possibility of occurrence of an abnormality in the network, the predetermined time interval for executing the process by the location identification result acquisition part 11 and the node visualization output part 12 may be shortened to control more detailed investigation monitoring.

If a predetermined change is made on the path to reach a predetermined target node within a predetermined time period, the node visualization output part 12 may visualize and output the degree of the predetermined change in at least one or more of the following elements of a numerical value, a figure, and a color. For example, as a result of the location identification by the location identification result acquisition part 11, if the length of a path to reach one target node is identified to be 1.5 times greater than the previous location identification result, the node visualization output part 12 may executes visualization such as blinking an icon, which is a figure indicating the target node.

### [Operation]

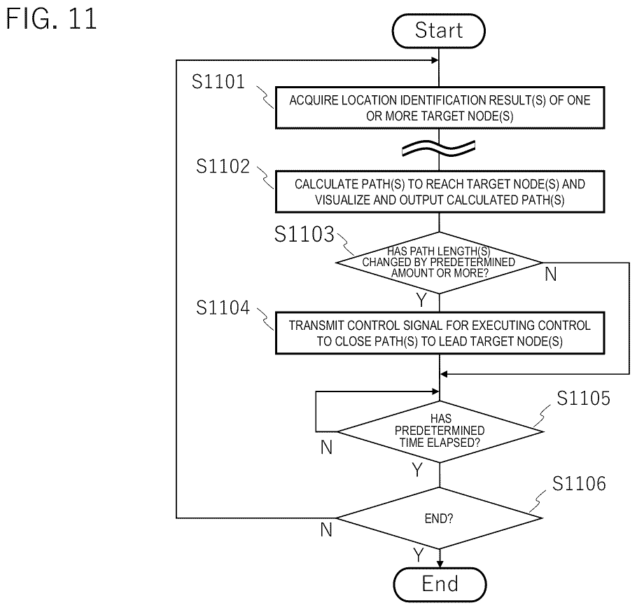

FIG. 11 is a flowchart illustrating an example of an operation of the investigation apparatus according to the example embodiment of the present disclosure. As illustrated in FIG. 11, if the investigation apparatus starts its operation, it acquires a location identification result(s) of one or more target node(s) (step S1101). Next, the investigation apparatus executes steps equivalent to steps S62 to S64 in FIG. 6 (description thereof is omitted). Next, the investigation apparatus calculates a path(s) to reach the target node(s) and visualizes and outputs thereof (step S1102). Next, the investigation apparatus determines whether or not the output path length(s) has changed from the path length(s) previously output by a predetermined amount or more (step S1103). If such change has been made (step S1103, Y), the investigation apparatus transmits a control signal for executing control to close the path(s) to lead the target node(s) to the control apparatus (step S1104). If no such change has been made (step S1103, N), the operation proceeds to step S1105, and the investigation apparatus determines whether a predetermined time has elapsed. If the predetermined time elapses, the operation proceeds to step S1106, and the investigation apparatus determines whether or not to end this operation. If the investigation apparatus determines not to end this operation, the operation returns to the process of acquiring the location identification result(s) (step S1101) again.

As described above, the investigation apparatus according to the present example embodiment can calculate and visualize a path(s) to reach a target node(s). In addition, by identifying the location of each target node at predetermined time intervals and calculating a path to reach thereof, it is possible to observe large fluctuations in the network path caused by failures, etc., and to perform a process for control to close or reroute the path.

### Third Example Embodiment

In a third example embodiment, a communication system including the investigation apparatus according to the second example embodiment and a network control apparatus for controlling communication paths will be described.

### [Apparatus Configuration]

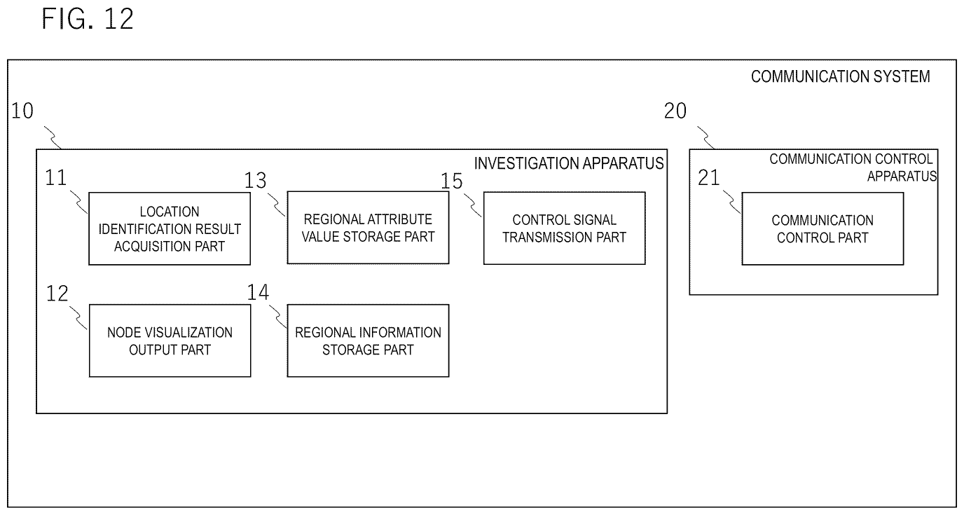

FIG. 12 is a diagram illustrating an example of a configuration of a communication system according to an example embodiment of the present disclosure. As illustrated in FIG. 12, the communication system according to the present example embodiment is provided with an investigation apparatus 10 and a communication control apparatus 20. The investigation apparatus 10 is provided with a location identification result acquisition part 11, a node visualization output part 12, a regional attribute value storage part 13, a regional information storage part 14, and a control signal transmission part 15. Since these components have already been described in the above example embodiments, description thereof will be omitted. A feature of the communication system according to the present example embodiment is that the communication system is provided with a communication control apparatus 20 and a communication control part 21, in addition to the components of the investigation apparatus 10 according to the second example embodiment.

The communication control apparatus 20 includes a network device or the like such as a router or a switch. The communication system may include a plurality of communication control apparatuses 20. The communication control part 21 receives a control signal transmitted from the control signal transmission part 15 and executes communication control. The “control signal” is a signal used to control a process such as blocking the communication path of packets to a specific destination, rerouting the communication path of packets to a specific destination, etc., as generally performed by routers and the like. The signal reception may be configured to intervene with device authentication or other processes to prevent unauthorized control signal reception.

According to the communication system of the present example embodiment, it is possible to execute appropriate communication control according to the state of the communication path(s). Even if a status on a path is unknown, especially on the Internet, visualization and monitoring a change(s) in path can reduce the risk of communication disruptions and delays caused by failures and other problems.

The above-described example embodiments can partly or entirely be described as, but not limited to, the following modes.

### [Mode 1]

See the investigation apparatus according to the above-described first aspect.

### [Mode 2]

The investigation apparatus according to mode 1, preferably, further including: a regional attribute value storage part that stores a regional attribute value associated with a latitude and longitude, which is a value indicating an attribute of the region at the latitude and longitude; and a regional information storage part that stores regional information associated with the regional attribute value, which is information about the region; wherein the node visualization output part outputs the information on the region to which the target node belongs, on a basis of the location identification result, the regional attribute value, and the regional information.

### [Mode 3]

The investigation apparatus according to mode 2, preferably, wherein the regional information storage part stores whether a region having a regional attribute value is at least domestic, foreign, maritime, or outside the visualization area, as regional information associated with the regional attribute value.

### [Mode 4]

The investigation apparatus according to mode 3, preferably, wherein the node visualization output part further calculates, visualizes, and outputs a path to reach the target node.

### [Mode 5]

The investigation apparatus according to mode 4, preferably, further including a control signal transmission part that transmits a signal to a communication control apparatus that controls communication to execute control of predetermined communication according to the path calculated by the node visualization output part.

### [Mode 6]

The investigation apparatus according to mode 5, preferably, wherein the control signal transmission part transmits a control signal to execute control of a predetermined communication, if there is a predetermined change within a predetermined time period on the path to reach a predetermined target node in the node visualization output part.

### [Mode 7]

The investigation apparatus according to mode 6, preferably, wherein the node visualization output part visualizes and outputs a degree of the predetermined change by at least one or more of a numerical value, a figure, and a color.

### [Mode 8]

The investigation apparatus according to mode 6, preferably, wherein the control signal transmission part transmits a control signal to execute control to close the path leading to the target node, if a path length to reach a predetermined target node is changed by a predetermined amount or more within a predetermined time in the node visualization output part.

### [Mode 9]

The investigation apparatus according to mode 5, preferably, wherein the control signal transmission part transmits a control signal to execute control of a predetermined communication, if a node outside the visualization area is included in a path to reach a predetermined target node in the node visualization output part.

### [Mode 10]

The investigation apparatus according to mode 4, preferably, wherein the node visualization output part outputs a predetermined warning if a maritime node is included in a path to reach a predetermined target node.

### [Mode 11]

The investigation apparatus according to mode 4, preferably, wherein the node visualization output part outputs a predetermined warning if a node outside the visualization area is included in a path to reach a predetermined target node.

### [Mode 12]

The investigation apparatus according to any one of modes 1 to 11, preferably, further including a location identification result edit part that edits the location identification result.

### [Mode 13]

See the communication system according to the above-described second aspect.

### [Mode 14]

See the investigation method according to the above-described third aspect.

### [Mode 15]

See the program according to the above-described fourth aspect.

The disclosure of the PTL, etc., which have been referred to in the above, is incorporated herein by reference thereto. Modifications and adjustments of the example embodiments or examples are possible within the scope of the overall disclosure (including the claims) of the present invention and on a basis of the basic technical concept of the present disclosure. Various combinations or selections (including eliminations) of various disclosed elements (including the elements in each of the claims, example embodiments, examples, drawings, etc.) are possible within the scope of the disclosure of the present invention. That is, the present disclosure of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

10: Investigation apparatus
11: Location identification result acquisition part
12: Node visualization output part
13: Regional attribute value storage part
14: Regional information storage part
15: Control signal transmission part
20: Communication control apparatus
21: Communication control part
71: CPU
72: Memory
73: Input-output interface
74: NIC
75: Internal bus

What is claimed is:

1. An investigation apparatus, comprising:
at least a processor; and
a memory in circuit communication with the processor,
wherein the processor is configured to execute program instructions stored in the memory to implement:
a location identification result acquisition part that acquires a location identification result of a target node to be investigated in a network; and
a node visualization output part that visualizes and outputs the target node by disposing the target node on a map, on a basis of the location identification result,
wherein the node visualization output part further outputs information on a region to which the target node belongs.

2. The investigation apparatus according to claim 1, further comprising:
a regional attribute value storage part that stores a regional attribute value associated with a latitude and longitude, which is a value indicating an attribute of the region at the latitude and longitude; and
a regional information storage part that stores regional information associated with the regional attribute value, which is information about the region;
wherein the node visualization output part outputs the information on the region to which the target node belongs, on a basis of the location identification result, the regional attribute value, and the regional information.

3. The investigation apparatus according to claim 2; wherein
the regional information storage part stores whether a region having a regional attribute value is at least domestic, foreign, maritime, or outside a visualization area, as regional information associated with the regional attribute value.

4. The investigation apparatus according to claim 3; wherein
the node visualization output part further calculates, visualizes, and outputs a path to reach the target node.

5. The investigation apparatus according to claim 4, further comprising:
a control signal transmission part that transmits a signal to a communication control apparatus that controls communication to execute control of predetermined communication according to the path calculated by the node visualization output part.

6. The investigation apparatus according to claim 5; wherein
the control signal transmission part transmits a control signal to execute control of a predetermined communication, if there is a predetermined change within a predetermined time period on the path to reach a predetermined target node in the node visualization output part.

7. The investigation apparatus according to claim 6; wherein
the node visualization output part visualizes and outputs a degree of the predetermined change by at least one or more of a numerical value, a figure, and a color.

8. The investigation apparatus according to claim 6; wherein
the control signal transmission part transmits a control signal to execute control to close the path leading to the target node, if a path length to reach a predetermined target node is changed by a predetermined amount or more within a predetermined time in the node visualization output part.

9. The investigation apparatus according to claim 5; wherein
the control signal transmission part transmits a control signal to execute control of a predetermined communication, if a node outside the visualization area is included in a path to reach a predetermined target node in the node visualization output part.

10. The investigation apparatus according to claim 4; wherein the node visualization output part outputs a predetermined warning if a maritime node is included in a path to reach a predetermined target node.

11. The investigation apparatus according to claim 4; wherein
the node visualization output part outputs a predetermined warning if a node outside the visualization area is included in a path to reach a predetermined target node.

12. The investigation apparatus according to claim 1, further comprising:
a location identification result edit part that edits the location identification result.

13. A communication system, comprising:
an investigation apparatus; comprising:
at least a processor; and
a memory in circuit communication with the processor,
wherein the processor is configured to execute program instructions stored in the memory to implement:
a location identification result acquisition part that acquires a location identification result of a target node to be investigated in a network;
a node visualization output part that visualizes and outputs the target node by disposing the target node on a map, on a basis of the location identification result, that outputs information on a region to which the target node belongs, and that calculates, visualizes and outputs a path to reach the target node; and
a control signal transmission part that transmits a signal to a communication control apparatus that controls communication to execute control of predetermined communication according to the path calculated by the node visualization output part, and
a communication control apparatus; comprising:
at least a processor; and
a memory in circuit communication with the processor,
wherein the processor is configured to execute program instructions stored in the memory to implement:
a communication control part that receives a control signal transmitted from the control signal transmission part and executes control of a communication.

14. An investigation method executed by a computer, comprising:
acquiring a location identification result of a target node to be investigated in a network; and
disposing the target node on a map on a basis of the location identification result and visualizing and outputting information on a region to which the target node belongs.

15. The investigation method according to claim 14, wherein
the computer comprises at least a processor and a memory in circuit communication with the processor, and
a regional attribute value associated with a latitude and longitude, which is a value indicating an attribute of the region at the latitude and longitude and regional information associated with the regional attribute value, which is information about the region are stored in the memory, and
the investigation method further comprising:
outputting the information on the region to which the target node belongs, on a basis of the location identification result, the regional attribute value, and the regional information.

16. The investigation method according to claim 15, wherein
the computer stores whether a region having a regional attribute value is at least domestic, foreign, maritime, or outside a visualization area, as regional information associated with the regional attribute value.

17. The investigation method according to claim 16, further comprising:
calculating, visualizing, and outputting a path to reach the target node.

18. The investigation method according to claim 17, further comprising:
transmitting a signal to a communication control apparatus that controls communication to control execute of predetermined communication according to the path calculated.

19. The investigation n method according to claim 17, further comprising:
outputting a predetermined warning if a maritime node is included in a path to reach a predetermined target node.

20. The investigation method according to claim 17, further comprising:
outputting a predetermined warning if a node outside the visualization area is included in a path to reach a predetermined target node.
